(19) United States
(12) Patent Application Publication
(10) Pub. No.: US 2026/0179647 A1
(43) Pub. Date: Jun. 25, 2026

(54) SOUND SOURCE ENHANCEMENT

(71) Applicant: Nokia Technologies Oy, Espoo (FI)

(72) Inventors: Jussi Artturi LEPPÄNEN, Tampere (FI); Miikka Tapani VILERMO, Tampere (FI); Arto Juhani LEHTINIEMI, Tampere (FI)

(21) Appl. No.: 19/185,851

(22) Filed: Apr. 22, 2025

(30) Foreign Application Priority Data
Apr. 29, 2024 (GB) 2405970.1

(51) Int. Cl. G10L 25/78; H04R 3/00

(52) U.S. Cl. CPC G10L 25/78; H04R 3/005

(57) ABSTRACT

An apparatus comprising means for:
modifying allowed directions, relative to a user head orientation, based on translational user movement;
starting a sound source enhancement mode to enhance a sound source from an allowed direction;
maintaining the sound source enhancement mode irrespective of head orientation of a user of the apparatus; and
ending the sound source enhancement mode when sound inactivity associated with the sound source is detected on the allowed direction.

### TECHNOLOGICAL FIELD

Examples of the disclosure relate to sound source enhancement. Some relate to conditions for starting sound source enhancement.

### BACKGROUND

When a user is listening to rendered audio, the rendered audio can isolate them from a sound source in the local environment. For example, when a user is wearing a head-mounted apparatus for rendering audio, they can be isolated from a sound source in the surrounding local environment.

It would be desirable to control sound source enhancement of a sound source in the surrounding local environment so that it can be heard.

### BRIEF SUMMARY

According to various, but not necessarily all, embodiments there is provided an apparatus comprising means for:
modifying allowed directions, relative to a user head orientation, based on translational user movement;
starting a sound source enhancement mode to enhance a sound source from an allowed direction;
maintaining the sound source enhancement mode irrespective of head orientation of a user of the apparatus; and
ending the sound source enhancement mode when sound inactivity associated with the sound source is detected on the allowed direction.

In some but not necessarily all examples, the apparatus comprises means for:
in dependence upon detecting a sound source at a detection direction that is an allowed direction, starting the sound source enhancement mode to enhance the sound source at the allowed direction.

In some but not necessarily all examples, opposing user lateral directions are perpendicular to a user frontal direction and a user rear direction, and the modifying allowed directions modifies allowed directions, relative to a user head orientation, based on a threshold of translational user movement to additionally include at least the opposing user lateral directions,
wherein the allowed directions, relative to a user head orientation, in the absence of the threshold of translational user movement include a user frontal direction but do not include the opposing user lateral directions.

In some but not necessarily all examples, the apparatus comprises means for:
in dependence upon detecting a sound source at a detection direction that is an allowed user lateral direction, starting a sound source enhancement mode to enhance the sound source at the allowed user lateral direction,
maintaining the sound source enhancement mode enhancing the sound source until the sound source enhancement mode ends.

In some but not necessarily all examples, the apparatus comprises means for: ending the sound source enhancement mode when speech inactivity is detected for a user of the apparatus.

In some but not necessarily all examples, the apparatus comprises means for:
after starting the sound source enhancement mode, while the apparatus has a location that is changing in time,
   maintaining the sound source enhancement mode irrespective of the head orientation of the user of the apparatus; and
   ending the sound source enhancement mode when speech inactivity is detected.

In some but not necessarily all examples, the apparatus comprises means for:
after starting the sound source enhancement mode, while the apparatus has a location that is changing in time and the sound source has a location that is changing similarly in time,
   maintaining the sound source enhancement mode irrespective of the head orientation of the user of the apparatus; and
   ending the sound source enhancement mode when speech inactivity is detected.

In some but not necessarily all examples, the apparatus comprises means for:
after starting the sound source enhancement mode, while the apparatus has a location that is changing in time and the sound source is within a threshold distance of the apparatus,
   maintaining the sound source enhancement mode irrespective of the head orientation of the user of the apparatus; and
   ending the sound source enhancement mode when speech inactivity is detected.

In some but not necessarily all examples, the apparatus comprises means for:
after starting the sound source enhancement mode, while the apparatus has a location that is not changing in time,
maintaining the speech enhancement mode while the head orientation of the user is towards the sound source such that the sound source is in front of the user; and
ending the sound source enhancement mode when sound source inactivity is detected in front of the user of the apparatus and speech inactivity of the user of the apparatus is detected.

In some but not necessarily all examples, the apparatus comprises means for ending the sound source enhancement mode when a timeout period expires; and extending or re-setting the timeout period based on one or more of:
audio activity of the sound source irrespective of relative orientation of the sound source to the apparatus;
speech detection of the user of the apparatus; and
head rotation of user of the apparatus towards the sound source.

In some but not necessarily all examples, the apparatus comprises means for detecting speech inactivity when the sound source has been audio inactive for a time exceeding a threshold time and speech of the user of the apparatus has been audio inactive for a time exceeding a threshold time.

In some but not necessarily all examples, the apparatus comprises means for tracking a location of the sound source;
wherein the means for maintaining the sound source enhancement mode irrespective of the head orientation of the user of the apparatus comprises means for maintaining the sound source enhancement mode while the tracked sound source remains audio active.

In some but not necessarily all examples, the apparatus comprises means for performing the sound source enhancement mode after the sound source enhancement mode has been started, while it is being maintained, comprising means for at least one of:
frequency filtering, equalizing or amplification of the sound source;
spatial filtering captured audio to track the sound source;
controlling passthrough/transparency individually for each ear;
suppressing captured sounds other than the sound source; or
modification of audio content being privately rendered to the user of the apparatus

In some but not necessarily all examples, speech activity detection is a necessary condition for starting the sound source enhancement mode.

In some but not necessarily all examples, speech activity detection for the user of the apparatus is a necessary condition for starting the sound source enhancement mode or
wherein speech sound source detection, irrespective of orientation relative to a head of the user is a necessary condition for starting the sound source enhancement mode.

In some but not necessarily all examples, any one or more of the following is an additional necessary condition for starting the sound source enhancement mode:
the apparatus has a location that is changing in time;
the apparatus has a location that is changing in time and the sound source has a has a location that is changing similarly in time; or
the apparatus has a location that is changing in time and the sound source is within a threshold distance of the apparatus.

In some but not necessarily all examples, the apparatus is configured as a head-mounted apparatus.

According to various, but not necessarily all, embodiments there is provided a method comprising:
modifying allowed directions, relative to a user head orientation, based on translational user movement;
starting a sound source enhancement mode to enhance a sound source from an allowed direction;
maintaining the sound source enhancement mode irrespective of head orientation of a user of the apparatus; and
ending the sound source enhancement mode when sound inactivity associated with the sound source is detected on the allowed direction.

In some but not necessarily all examples, the method comprises:
in dependence upon detecting a sound source at a detection direction that is an allowed direction, starting a sound source enhancement mode to enhance the sound source at the allowed direction.

According to various, but not necessarily all, embodiments there is provided a computer program that when executed by one or more processors of an apparatus causes the apparatus to:
modify allowed directions, relative to a user head orientation, based on translational user movement;
start a sound source enhancement mode to enhance a sound source from an allowed direction;
maintain the sound source enhancement mode irrespective of head orientation of a user of the apparatus; and
ending the sound source enhancement mode when sound inactivity associated with the sound source is detected on the allowed direction.

According to various, but not necessarily all, embodiments there is provided an apparatus comprising means for:
modifying allowed directions, relative to a user head orientation, based on translational user movement;
in dependence upon detecting a sound source at a detection direction that is an allowed direction, starting a sound source enhancement mode to enhance the sound source at the allowed direction.

According to various, but not necessarily all, embodiments there is provided an apparatus comprising means for:
modifying allowed directions, relative to a user head orientation, based on translational user movement;
starting a sound source enhancement mode to enhance a sound source from an allowed direction;
maintaining the sound source enhancement mode irrespective of head orientation of a user of the apparatus; and
ending the sound source enhancement mode when speech inactivity is detected.

According to various, but not necessarily all, embodiments there is provided an apparatus comprising means for:
starting a sound source enhancement mode to enhance a sound source from an allowed direction;
maintaining the sound source enhancement mode irrespective of head orientation of a user of the apparatus; and
ending the sound source enhancement mode when speech inactivity is detected.

According to various, but not necessarily all, embodiments there is provided an apparatus comprising means for:
starting a sound source enhancement mode to enhance a sound source from an allowed direction;
maintaining the sound source enhancement mode irrespective of head orientation of a user of the apparatus; and
ending the sound source enhancement mode when sound inactivity associated with the sound source is detected on the allowed direction.

According to various, but not necessarily all, embodiments there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all the features described in respect of other examples of the disclosure, and vice versa. Also, it is to be appreciated that any one or more or all the features, in any combination, may be implemented by/comprised in/performable by an apparatus, a method, and/or computer program instructions as desired, and as appropriate. The description of a function should additionally be considered to also disclose any means suitable for performing that function

### BRIEF DESCRIPTION

Some examples will now be described with reference to the accompanying drawings in which:

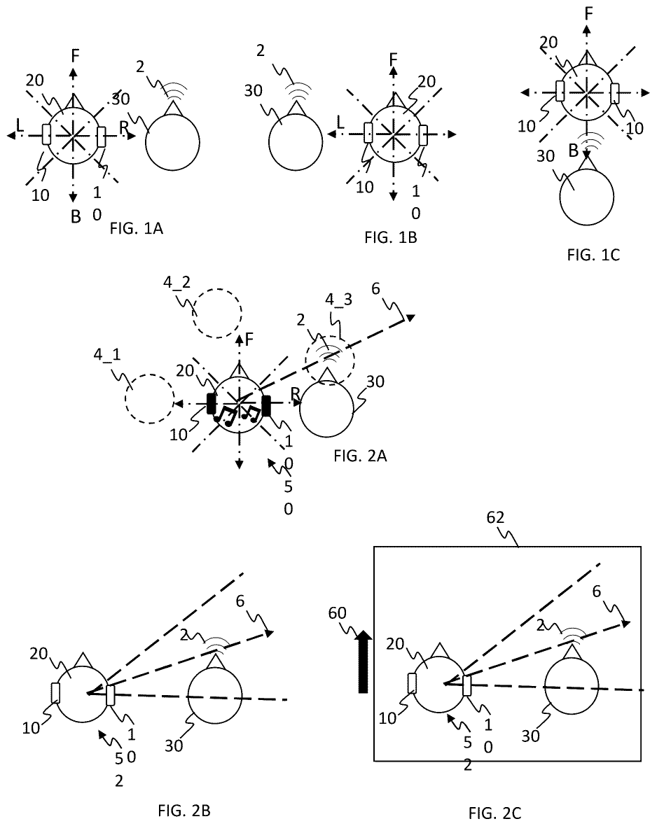

FIGS. 1A, 1B, 1C illustrate examples of a sound source 2 at different directions relative to a user wearing an apparatus 10;

FIG. 2A illustrates as an example, the apparatus 10 during a mode 50 without sound source enhancement;

FIG. 2B and FIG. 2C illustrates as examples, the apparatus 10 during a source enhancement mode 52;

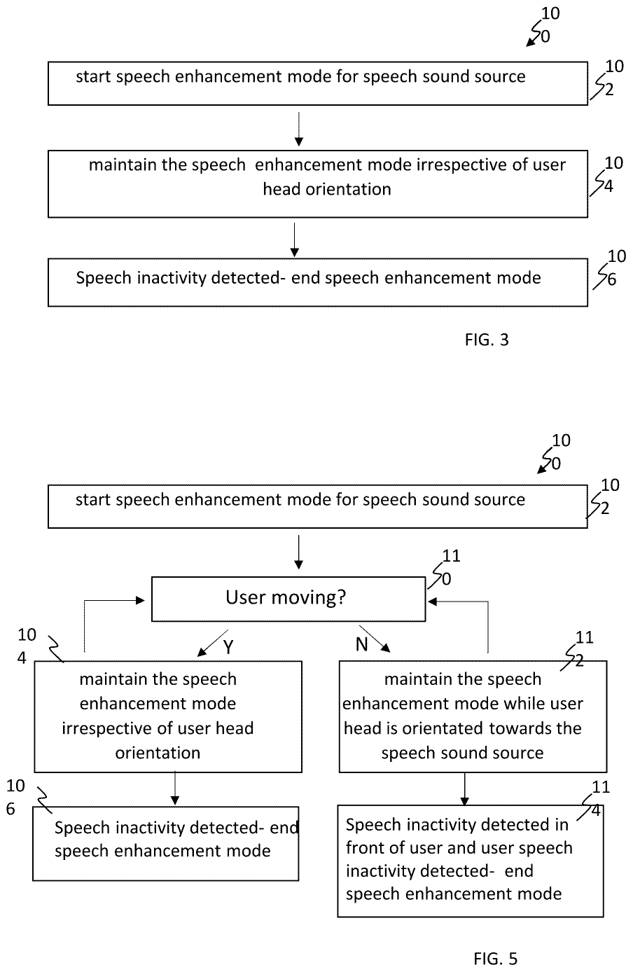

FIG. 3 illustrates an example of a method 100 for starting, maintaining and ending sound source enhancement mode 52;

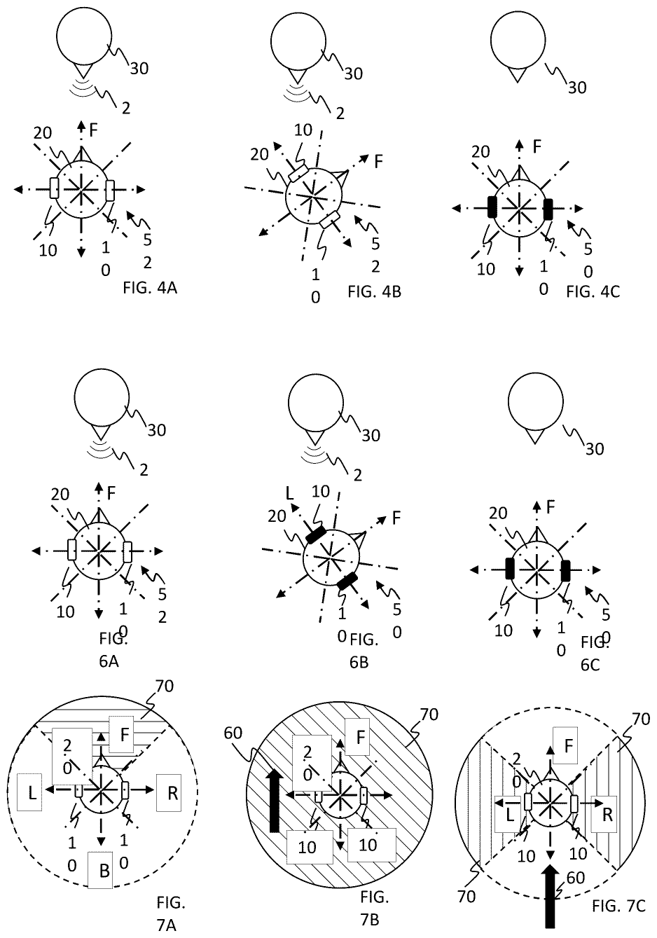

FIGS. 4A and 4B illustrate examples of maintaining the sound source enhancement mode 52 irrespective of an orientation of a head 20 of the user of the apparatus 10;

FIG. 4C illustrates ending the sound source enhancement mode 52 when sound inactivity is detected;

FIG. 5 illustrates an example of a method 100 for starting, maintaining and ending sound source enhancement mode 52 with different outcomes depending upon whether the apparatus 10 is moving (changing location in time);

FIG. 6A illustrates maintaining the speech enhancement mode 52 only while the head orientation of the user is towards the sound source 2 such that the sound source 2 is in front of the user of the apparatus 10;

FIGS. 6B and 6C illustrate ending the sound source enhancement mode 52 when sound source inactivity is detected in front of the user of the apparatus 10.

FIG. 7A illustrates a range of allowed direction 70 that is limited to the front direction (F);

FIGS. 7B and 7C illustrate a range of allowed directions 70 that are not limited to the front direction (F) and include the left direction (L) and the right direction (R);

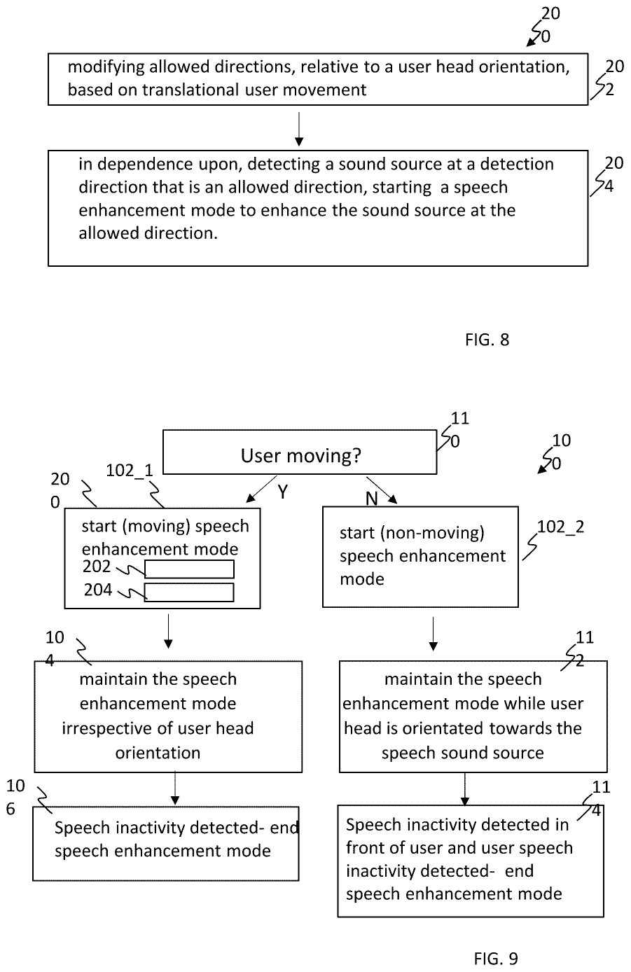

FIG. 8 illustrates an example of a method 200 for starting sound enhancement based on modified allowed directions 70;

FIG. 9 illustrates an example of a method 100 for starting, maintaining and ending sound source enhancement mode 52 with different outcomes depending upon whether the apparatus 10 is moving (changing location in time);

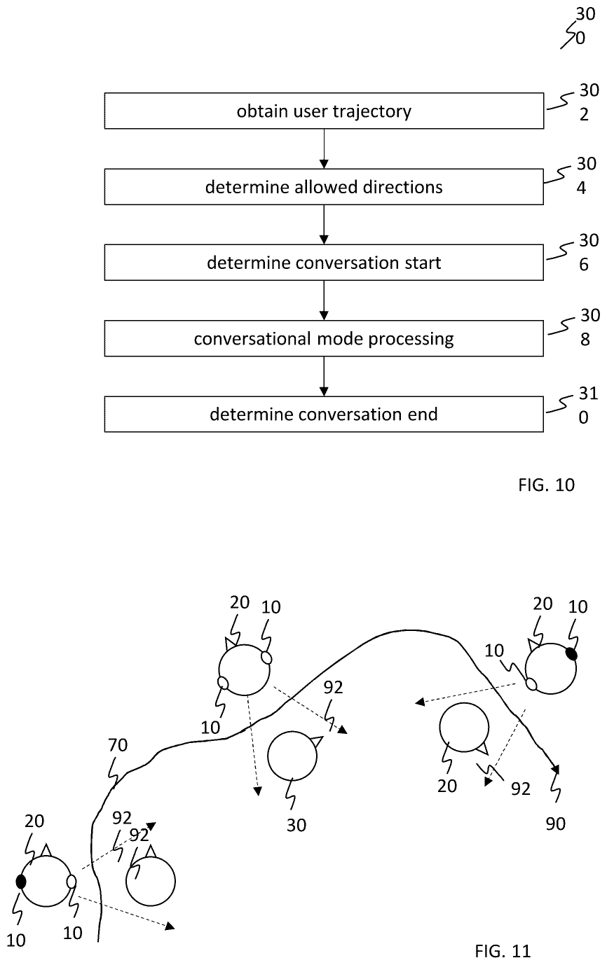

FIGS. 10 and 11, illustrate an example where the apparatus 10 after starting the sound source enhancement mode 52, conditionally maintains the sound source enhancement mode 52 based on continuing translational movement of the apparatus 10 (it has a location that is changing in time);

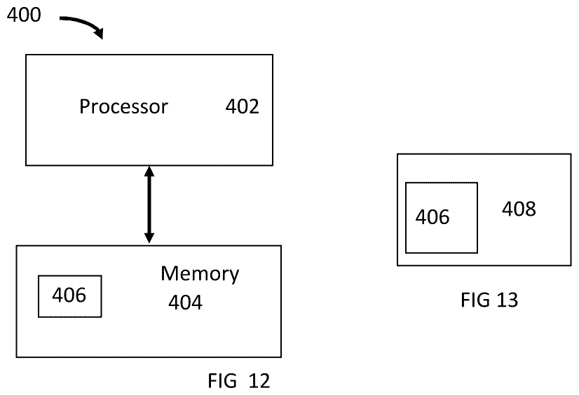

FIG. 12 illustrates an example of a controller 400 for the apparatus 10;

FIG. 13 illustrates an example of a code 406 for controlling the apparatus 10.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

The reference number 20 will be used to refer to the user and a head of a user.

The reference number 30 will be used to refer to a speaker (another person speaking) and a head of a speaker.

The phrase changing “in time” means that there is a changing “with respect to time”, that is changing “over time”.

### DETAILED DESCRIPTION

At least some of the FIGs illustrate an apparatus 10 comprising means for:
starting a sound source enhancement mode 52 to enhance a sound source 2 from an allowed direction 70;
maintaining the sound source enhancement mode 52 irrespective of head orientation of a user of the apparatus 10; and
ending the sound source enhancement mode 52 when speech inactivity is detected.

At least some of the FIGs illustrate an apparatus 10 (additionally or alternatively) comprising means for:
modifying allowed directions 70, relative to a user head orientation, based on translational user movement 60;
in dependence upon detecting a sound source 2 at a detection direction 6 that is an allowed direction 70, starting a sound source enhancement mode 52 to enhance the sound source 2 at the allowed direction.

FIGS. 1A, 1B, 1C illustrate a sound source 2 at different directions relative to a user head 20. The apparatus 10 is worn on the user head 20. The directions front (F), left (L), right (R) and back (B) are defined relative to the user head 20. The front direction (F) and the back direction (B) are opposing and orthogonal to the opposing left direction (L) and right direction (R). In these examples, the sound source 2 is speech produced by a speaker 30.

The apparatus 10 comprises means for starting a sound source enhancement mode to enhance the sound source 2.

In FIG. 1A, the sound source 2 is to the right direction (R). The user and speaker are side by side looking in the same forward direction (F). The user head 20 and the speaker head 30 are oriented in the same forward direction (F) with the speaker head 30 to the right (R) of the user head 20.

In FIG. 1B, the sound source 2 is to the left direction (L). The user and speaker are side by side looking in the same forward direction (F). The user head 20 and the speaker head 30 are oriented in the same forward direction (F) with the speaker head 30 to the left (L) of the user head 20.

In FIG. 1C, the sound source 2 is to the rear in the back direction (B). The user is in front of the speaker and both are looking in the same forward direction (F). The user head 20 and the speaker head 30 are oriented in the same forward direction (F) with the speaker head 30 to behind (B) the user head 20.

In at least some examples, the apparatus 10 comprises means for:
starting a sound source enhancement mode to enhance a sound source 2 from an allowed direction 70 or directions 70.

For the sound source enhancement mode 52 to operate in accordance with FIG. 1A the allowed directions include the right direction (R). To operate in accordance with FIG. 1B the allowed directions include the left direction (L). To operate in accordance with FIG. 1C the allowed directions include the back direction (B). To operate in accordance with FIGS. 1A & 1B the allowed directions include the left direction (L) and the right direction (R). To operate in accordance with FIGS. 1A & 1B but not FIG. 1C the allowed directions include the left direction (L) and the right direction (R) and exclude the back direction (B). To operate in accordance with FIGS. 1A, 1B and 1C the allowed directions include the left direction (L), the right direction (R) and the back direction (B).

The allowed directions can be different and can be determined to be different. For example, the surrounding area (or volume) can be divided into 2D or 3D sectors.

The sectors could for example include more precise 2D sectors such as not only Front (F), Back (B), Left (L) and Right (R), but intermediate directions such as any one or more of: Front-Left (FL) which is intermediate Front (F) and Left (L); Front-Right (FR) which is intermediate Front (F) and Right (R); Back-Left (BL) which is intermediate Back (B) and Left (L); Back-Right (BR) which is intermediate Back (B) and Right (R).

The apparatus 10, in at least some examples, is configured as a head-mounted apparatus. A head-mounted apparatus has, for example, an audio output apparatus for one or each ear of the user. An audio output apparatus can be configured to be over-ear, on-ear, or in-ear. Examples of a head-mounted apparatus include headphones, ear bud(s), hearing aid(s) etc.

The relationship between the user 20 of the apparatus 10 and the speaker 30 illustrated in FIGS. 1A, 1B, 1C could for example occur in various situations including, but not limited to, when the user of the apparatus 10 and the speaker 30 are travelling in a vehicle or otherwise travelling together. Two persons are next to each other and facing the same direction or one is behind the other facing the same direction while driving, while seated in a bus, while cycling, etc.

FIG. 2A illustrates the apparatus 10 during a mode 50 without sound source enhancement (before a sound source enhancement mode 52 as illustrated in FIG. 2B or 2C has been started).

In this example, during the mode 50, the user listens to rendered audio content. The audio content is in some examples spatial audio content comprising audio content audio sources 4_i at different controllable bearings from the user of the apparatus 10. The audio content can also comprise ambient content that does not have a specific bearing.

A sound source 2 is detected and it is determined whether it satisfies selection criteria. If it does, it is a selected sound source 2. A sound source enhancement mode 52 is started to enhance the selected sound source 2.

The sound source enhancement mode 52 can, for example, modify rendering of the audio content.

The sound source enhancement mode 52 can, for example, reduce the intensity of (or switch off) all audio content audio sources 4_i or audio content audio sources 4_i that are within a threshold bearing of the selected sound source 2.

The sound source enhancement mode 52 can, for example, reduce the intensity of (or switch off) ambient content such as, for example, ambient music. The sound source enhancement mode 52 can, for example, introduce spatiality to the ambient content by reducing the intensity of (or switch off) all ambient audio content within a threshold bearing of the selected sound source 2.

The sound source enhancement mode 52 can, for example, modify rendering or attenuation of the selected sound source 2.

In some examples, the allowed directions, which are defined relative to an orientation of the user head 20, are modified based on translational user movement.

In some examples, the sound source enhancement mode 52 is maintained irrespective of an orientation of a user head 20.

FIG. 2B illustrates an apparatus 10 comprising means for starting a sound source enhancement mode 52 to enhance a sound source 2 from an allowed direction 70 or directions 70 that is not a frontal direction (F).

In some examples, the apparatus 10 is configured to modify the allowed directions, relative to a user head 20 orientation, based on translational user movement.

In some examples, the apparatus 10 is configured to maintain the sound source enhancement mode 52 irrespective of an orientation of a user head 20.

FIG. 2C illustrates an apparatus 10 comprising means for starting a sound source enhancement mode 52 to enhance a sound source 2 from an allowed direction 70 or directions 70 that is not a frontal direction (F).

In some examples, the apparatus 10 is configured to modify the allowed directions, relative to a user head orientation, based on translational user movement 60.

In some examples, the apparatus 10 is configured to maintain the sound source enhancement mode 52 irrespective of an orientation of a user head 20.

In this example, the user is moving 60 but the speaker 30 is not moving (or not moving significantly) relative to the user. In this example, the user and the speaker share a frame of reference 62 that is moving 60 through space.

In some examples, the apparatus 10 is configured to modify the allowed directions, relative to a user head 20 orientation, based on translational user movement 60 above a first threshold value and relative translational user movement of the sound source 2 with respect to the user that is below a second threshold. In some examples the second threshold can is less than the first threshold. In some examples the second threshold can is equal to the first threshold.

In at least some examples, the means for performing the sound source enhancement mode 52 after the sound source enhancement mode 52 has been started, while it is being maintained, comprises means for
frequency filtering, equalizing or amplification of the sound source 2;
spatial filtering captured audio to track the sound source 2;
controlling passthrough/transparency individually for each ear;
suppressing captured sounds other than the sound source 2;
modification of audio content being privately rendered to the user of the apparatus 10.

In at least some example, the means for performing the sound source enhancement mode 52 after the sound source enhancement mode 52 has been started, while it is being maintained, comprises means for speech enhancement. This can use frequency filtering, equalizing or amplification or other techniques to improve audio perception of a human voice.

The modification of audio content being privately rendered to the user 20 can be a modification of any one or more of: volume, changing the direction of the content so that it is separated from the sound source 2, muting the audio content.

In at least some examples, the voice of the person (speaker 30) the user 20 is talking to is enhanced and background noise suppressed via signal processing methods.

This can, for example, include spatial filtering, for example, adaptive beamforming to the direction of the sound source 2 (not front fixed beamforming).

In some examples, the apparatus 10 comprises means for:
starting a sound source enhancement mode 52 to enhance a sound source 2 from an allowed direction 70 or directions 70;
maintaining the sound source enhancement mode 52 irrespective of an orientation of a user head 20; and
ending the sound source enhancement mode 52 when sound inactivity is detected.

In some examples, sound inactivity is speech inactivity of the user 20.

In some examples, sound inactivity is speech inactivity of the speaker 30.

In some example, sound inactivity is speech inactivity of both the user 20 and the speaker 30.

FIG. 3 illustrates an example of a method 100 for starting, maintaining and ending sound source enhancement.

Block 102 of the method 100 comprises: starting a sound source enhancement mode 52 to enhance a sound source 2 from an allowed direction 70 or directions 70.

Block 104 of the method 100 comprises: maintaining the sound source enhancement mode 52 irrespective of an orientation of a user head 20.

Block 106 of the method 100 comprises: ending the sound source enhancement mode when sound inactivity is detected.

In some, but not necessarily all examples, speech activity detection is a necessary condition for starting the sound source enhancement mode 52.

In some, but not necessarily all examples, speech activity detection for the user 20 of the apparatus 10 is a necessary condition for starting the sound source enhancement mode 52.

In some, but not necessarily all examples, it is a necessary condition for starting the sound source enhancement mode 52 that the sound source 2 is at an allowed direction.

In some, but not necessarily all examples, speech sound source 2 detection is a necessary condition for starting the sound source enhancement mode 52. In some, but not necessarily all examples, speech sound source detection, at an allowed direction 70 relative to a head of the user is a necessary condition for starting the sound source enhancement mode 52. In some, but not necessarily all examples, speech sound source detection, irrespective of orientation relative to a head of the user is a necessary condition for starting the sound source enhancement mode 52.

In some, but not necessarily all examples, any one or more of the following is a necessary condition for starting the sound source enhancement mode 52:
the apparatus 10 has translational movement (it has a location that is changing in time);
the apparatus 10 has a location that is changing in time and the sound source 2 has a location that is changing similarly in time;
the apparatus 10 has a location that is changing in time and the sound source 2 is within a threshold distance of the apparatus 10.

In some, but not necessarily all examples, any one or more of the following is a necessary condition for starting the sound source enhancement mode 52:
a user command,
environment detection,
a frequency distribution requirement for the sound source 2;
a speech content requirement for the sound source 2 (e.g. detection of key words);
the sound source 2 is relatively loud compared to other external audio;
the sound source 2 is a sole speech sound source 2;
the apparatus 10 has a location that is changing in time but there is no (or little) change in loudness of the sound source 2 (implies a common trajectory).

In some but not necessarily all examples the same criteria for starting the sound source enhancement mode 52 are used to maintain the sound source enhancement mode 52.

In some but not necessarily all examples different criteria are used for starting the sound source enhancement mode 52 and for maintaining the sound source enhancement mode 52. In some but not necessarily all examples, a first set of the criteria listed as optional necessary conditions for starting the sound source enhancement mode 52 are used for starting the sound source enhancement mode 52 and a second, different, set of the criteria listed as optional necessary conditions for starting the sound source enhancement mode 52 are used for maintaining the sound source enhancement mode 52.

In some examples, the apparatus 10 comprises means for tracking a location of the sound source 2. The means for maintaining the sound source enhancement mode 52 comprises means for maintaining the sound source enhancement mode 52 while the tracked sound source 2 remains audio active (producing audio). In some example, the means for maintaining the sound source enhancement mode 52 maintains the sound source enhancement mode 52 while the tracked sound source 2 remains audio active, irrespective of the head orientation of the user of the apparatus 10 relative to the tracked sound source 2.

In some but not necessarily all examples the apparatus 10 comprises means for ending the sound source enhancement mode 52 when a timeout period expires; and extending or re-setting the timeout period based on one or more of:
audio activity of the sound source 2;
audio activity of the sound source 2 at an allowed direction;
audio activity of the sound source 2 irrespective of relative orientation to the user of the apparatus 10;
speech detection of the user of the apparatus 10;
head rotation of user of the apparatus 10 towards the sound source 2; and
distance of the sound source is not within a threshold anymore.

The apparatus 10 can, for example, comprise means for detecting sound inactivity when the sound source 2 has been audio inactive for a time exceeding a threshold time and speech of the user of the apparatus 10 has been audio inactive for a time exceeding a threshold time.

FIGS. 4A and 4B illustrate examples of maintaining the sound source enhancement mode 52 irrespective of an orientation of a user head 20.

FIG. 4C illustrates an example of ending the sound source enhancement mode 52 when sound inactivity is detected.

FIG. 5 illustrates a further example of the method 100 previously illustrated in FIG. 3.

As in FIG. 3:

Block 102 of the method 100 comprises: starting a sound source enhancement mode 52 to enhance a sound source 2 from an allowed direction 70 or directions 70

Block 104 of the method 100 comprises: maintaining the sound source enhancement mode 52 irrespective of an orientation of a user head 20.

Block 106 of the method 100 comprises: ending the sound source enhancement mode 52 when sound inactivity is detected.

Block 102 of the method 100 comprises: starting a sound source enhancement mode 52 to enhance a sound source 2 from an allowed direction 70 or directions 70.

Block 110 of the method 100 comprises: determining whether or not the apparatus 10 is moving (changing location intime). If the apparatus 10 is moving (changing location in time) the method branches to block 104. If the apparatus 10 is not moving (not changing location in time) the method branches to block 112.

For example, if a change location in time exceeds a threshold the method branches to block 104 and if it does not exceed the threshold the method branches to block 112.

After starting the sound source enhancement mode 52, while the apparatus 10 is moving (changing location in time), the method 100 performs block 104.

Block 104 of the method 100 comprises: maintaining the sound source enhancement mode 52 irrespective of an orientation of a user head 20.

Block 106 of the method 100 comprises: ending the sound source enhancement mode 52 when sound inactivity is detected.

FIGS. 4A and 4B illustrate in combination maintaining the sound source enhancement mode 52 irrespective of an orientation of a user head 20. FIG. 4C illustrates ending the sound source enhancement mode 52 when sound inactivity is detected.

After starting the sound source enhancement mode 52, while the apparatus 10 is not moving (not changing location intime), the method 100 performs block 112.

Block 112 of the method 100 comprises: maintaining the speech enhancement mode while the head orientation of the user is towards the sound source 2 such that the sound source 2 is in front of the user.

Block 114 of the method 100 comprises: ending the sound source enhancement mode 52 when sound source inactivity is detected in front of the user of the apparatus 10 and speech inactivity of the user of the apparatus 10 is detected.

FIG. 6A illustrates maintaining the speech enhancement mode only while the head orientation of the user is towards the sound source 2 such that the sound source 2 is in front of the user. FIGS. 6B and 6C illustrate ending the sound source enhancement mode 52 when sound source inactivity is detected in front of the user of the apparatus 10. In FIG. 6B sound source inactivity is detected in front of the user of the apparatus 10 because the relative position of the sound source 2 and the apparatus 10 has changed, in this example because the user of the apparatus 10 has turned their head. In FIG. 6C sound source inactivity is detected in front of the user of the apparatus 10 because although the relative position of the sound source 2 and the apparatus 10 has not changed, the sound source 2 is audio inactive.

FIG. 7A illustrates a range of allowed directions 70 that is limited to the front direction (F). FIGS. 7B and 7C illustrate a range of allowed directions 70 that is not limited to the front direction (F). FIGS. 7B and 7C illustrate a range of allowed directions 70 that include the left direction (L) and the right direction (R). In FIG. 7B, the allowed directions 70 include the left direction (L), the right direction (R) and the back direction (B) and the front direction (F). This can be used for operation in accordance with FIGS. 1A, 1B and 1C. In FIG. 7C, the allowed directions 70 includes the right direction (R) and the left direction (L) but not the front direction (F) or the back direction (B). This can be used for operation in accordance with FIG. 1A and/or FIG. 1B.

In some examples, the allowed directions 70 are adaptive.

In the examples illustrated in FIGS. 7A, 7B, 7C the allowed directions 70 adapt with movement 60 (change in location) of the apparatus 10.

In FIG. 7A, the apparatus 10 is stationary. The range of allowed direction 70 is limited to the front direction (F). The range of allowed direction 70 does not include the left direction (L), the right direction (R) or the rear direction (B). The sound source enhancement mode 52 can be started when a sound source 2 is detected at a detection direction 6 (not illustrated) that is an allowed direction 70 (front direction only).

In FIG. 7B or 7C, the apparatus 10 is in motion (changing location). The range of allowed direction 70 is no-longer limited to the front direction (F). The sound source enhancement mode 52 can be started when a sound source 2 is detected at a detection direction 6 (not illustrated) that is an allowed direction 70 (not front direction only).

In at least some examples, the apparatus 10 comprises means for:
modifying allowed directions 70, relative to a user head orientation, based on translational user movement 60. The term translational user movement relates to motion of the apparatus 10 (changing location rather than changing orientation).

The apparatus 10 comprises means for, in dependence upon detecting a sound source 2 at a detection direction 6 (not illustrated) that is an allowed direction 70, starting a sound source enhancement mode 52 to enhance the sound source 2 at the allowed direction 70.

In some examples, the sound source enhancement mode 52, once started, is maintained irrespective of the subsequent direction of the sound source 2.

In some examples, the sound source enhancement mode 52, once started, is only maintained while the subsequent direction of the sound source 2 is within the range of allowed directions 70.

In some examples, during the sound source enhancement mode 52, a detection direction 6 changes as the relative position of the user and speaker change during a conversation (the speaker 30 is tracked) and an allowed direction 70 could be updated accordingly (tracking the speaker 30).

The apparatus 10 comprises means for:
modifying allowed directions 70, relative to an orientation of a user's head 20, based on translational user movement 60;
in dependence upon detecting a sound source 2 at a detection direction 6 (not illustrated) that is an allowed direction, starting a sound source enhancement mode 52 to enhance-the sound source 2 at the allowed direction 70.

In the FIGs, opposing user lateral directions (L, R) are perpendicular to the opposing user frontal direction (F) and a user rear direction (B).

In at least some examples, the apparatus 10 comprises means for:
modifying allowed directions 70, relative to an orientation of a user's head 20, based on a threshold of translational user movement, to additionally include at least the opposing user lateral directions (L, R). This is illustrated in FIGS. 7B and 7C. In some examples, the allowed directions 70, relative to a user head orientation, in the absence of the threshold of translational user movement 60 include a user frontal direction (F) but do not include the opposing user lateral directions (L, R). This is illustrated in FIG. 7A.

In at least some examples, the apparatus 10 comprises means for:
in dependence upon detecting a sound source 2 at a detection direction 6 that is an allowed user lateral direction (L, R), starting a sound source enhancement mode 52 to enhance the sound source 2 at the allowed user lateral direction (L, R), and maintaining the sound source enhancement mode 52 enhancing the sound source 2 until the sound source enhancement mode 52 ends.

FIG. 8 illustrates an example of a method 200 for starting sound enhancement based on modified allowed directions 70.

Block 202 of the method 200 comprises: modifying allowed directions 70, relative to a user head orientation, based on translational user movement;

Block 204 of the method 100 comprises: in dependence upon detecting a sound source 2 at a detection direction 6 that is an allowed direction, starting a sound source enhancement mode 52 to enhance the sound source 2 at the allowed direction.

The method 200 can be used within the method 100 illustrated in FIG. 3 as block 102 of the method 100 where a sound source enhancement mode 52 is started to enhance a sound source 2 from an allowed direction 70 or directions 70. The requirement of detecting a sound source 2 at a detection direction 6 that is an allowed direction 70 is a necessary condition for starting the sound source enhancement mode 52.

There can be additional necessary conditions for starting the sound source enhancement mode 52, for example, as described with reference to FIG. 3, for example: the sound source 2 is moving (change of location) similarly to the apparatus 10, the sound source 2 is within a threshold distance of the apparatus 10, a user command, environment detection, frequency distribution requirement for the sound source 2; speech content requirement for the sound source 2 (e.g. detection of key words), the sound source 2 is relatively loud compared to other external audio, the sound source 2 is a sole speech sound source 2, the apparatus 10 has a location that is changing in time but there is no (or little) change in loudness of the sound source 2 (implies a common trajectory).

FIG. 9 illustrates a further example of the method 100 previously illustrated in FIG. 3 which includes the method 200 at block 102 when the apparatus 10 has translational movement.

As in FIG. 3:

Block 102 of the method 100 comprises: starting a sound source enhancement mode 52 to enhance a sound source 2 from an allowed direction 70 or directions 70.

Block 104 of the method 100 comprises: maintaining the sound source enhancement mode 52 irrespective of an orientation of a user head 20.

Block 106 of the method 100 comprises: ending the sound source enhancement mode 52 when sound inactivity is detected.

The block 102 is dependent upon whether the apparatus 10 is moving (that is has translational movement, that is a changing location).

Block 110 of the method 100 comprises: determining whether or not the apparatus 10 is moving (changing location in time). If the apparatus 10 is moving (changing location in time) the method branches to block 102_1. If the apparatus 10 is not moving (not changing location in time) the method branches to block 102_2.

If the apparatus 10 is moving (that is has translational movement, that is a changing location), then the block 102_1 is performs the method 200.

Block 202 of the method 200 comprises: modifying allowed directions 70, relative to a user head orientation, based on translational user movement. For example, modifying allowed directions 70 from the default forward directions (F) only, as illustrated in FIG. 7A, so that the allowed directions 70 include (FIG. 7B) or are restricted to (FIG. 7C) the lateral directions (the left direction (L) or the right direction (R)).

Block 204 of the method 100 comprises: in dependence upon detecting a sound source 2 at a detection direction 6 that is a (modified) allowed direction, starting a sound source enhancement mode 52 to enhance the sound source 2 at the allowed direction.

Thus in this example block 102_1 of the method 100, starts a sound source enhancement mode 52 to enhance the sound source 2 at the allowed direction 70 in dependence upon detecting a sound source 2 at a detection direction 6 that is not a default allowed direction (the forward direction F). The sound source enhancement mode 52 is started upon detecting a sound source 2 at a detection direction 6 that is a lateral direction (the left direction (L) or the right direction (R).

After starting the sound source enhancement mode 52 while the apparatus 10 is moving (changing location in time), the method 100 performs block 104.

Block 104 of the method 100 comprises: maintaining the sound source enhancement mode 52 irrespective of an orientation of a user head 20.

Block 106 of the method 100 comprises: ending the sound source enhancement mode 52 when sound inactivity is detected.

FIGS. 4A and 4B illustrate in combination an example of maintaining the sound source enhancement mode 52 irrespective of an orientation of a user head 20. FIG. 4C illustrates an example of ending the sound source enhancement mode 52 when sound inactivity is detected.

If the apparatus 10 is not moving (that is has translational movement, that is a changing location), then the method moves to block 102_2.

Block 102_2 of the method 100, starts a sound source enhancement mode 52 to enhance the sound source 2 at the allowed direction 70 in dependence upon detecting a sound source 2 at a detection direction 6 that is a default allowed direction (the forward direction F). The sound source enhancement mode 52 is not started upon detecting a sound source 2 at a detection direction 6 that is not the default allowed direction (the forward direction F).

After starting the sound source enhancement mode 52 while the apparatus 10 is not moving (not changing location in time), the method 100 performs block 112.

Block 112 of the method 100 comprises: maintaining the speech enhancement mode while the head orientation of the user is towards the sound source 2 such that the sound source 2 is in front of the user.

Block 114 of the method 100 comprises: ending the sound source enhancement mode 52 when sound source inactivity is detected in front of the user of the apparatus 10 and speech inactivity of the user of the apparatus 10 is detected.

FIG. 6A illustrates an example of maintaining the speech enhancement mode while the head orientation of the user is towards the sound source 2 such that the sound source 2 is in front of the user.

FIGS. 6B and 6C illustrate examples of ending the sound source enhancement mode 52 when sound source inactivity is detected in front of the user of the apparatus 10. In FIG. 6B sound source inactivity is detected in front of the user of the apparatus 10 because the relative position of the sound source 2 and the apparatus 10 has changed, in this example because the user of the apparatus 10 has turned their head. In FIG. 6C sound source inactivity is detected in front of the user of the apparatus 10 because although the relative position of the sound source 2 and the apparatus 10 has not changed, the sound source 2 is audio inactive.

FIGS. 10 and 11, illustrate an example where the apparatus 10 after starting the sound source enhancement mode 52, conditionally maintains the sound source enhancement mode 52 based on continuing translational movement of the apparatus 10 (it has a location that is changing in time).

In some examples, while the apparatus 10 has a location that is changing in time then the sound source enhancement mode 52 is maintained. An optional requirement can be that the direction to the sound source 2 remains an allowed direction. A optional requirement can be that distance between a user 20 and the sound source remains within a threshold. An optional requirement can be that the direction to the sound source 2 remains an allowed direction and a distance between a user 20 and the sound source remains within a threshold.

In some examples the apparatus 10 after starting the sound source enhancement mode 52, conditionally maintains the sound source enhancement mode 52 based on a relative change in displacement of the apparatus 10 and the sound source 2 remaining below a threshold while the apparatus 10 is undergoing translational movement 60 (changing location).

In some examples, while the apparatus 10 has a location that is changing in time and the sound source 2 has a location that is changing similarly in time, then the sound source enhancement mode 52 is maintained.

In some examples, while the apparatus 10 has a location that is changing in time and the sound source 2 is within a threshold distance of the apparatus 10, then the sound source enhancement mode 52 is maintained.

In some examples, while the apparatus 10 has a location that is changing in time and the sound source 2 is above a threshold loudness, then the sound source enhancement mode 52 is maintained.

Block 302 of the method 300 comprises: obtaining a user trajectory. This can be involve obtaining a trajectory of the apparatus 10. In some examples a trajectory is translational movement, that is, a change in location in time. In some examples a trajectory is a change in position (location, orientation) in time.

Block 304 of the method 300 comprises: obtaining the allowed directions 70, for example as previously described. This block can, for example, be the same as block 202 (FIG. 8).

Block 306 of the method 300 comprises: determining that the sound source enhancement mode 52 starts. This block can, for example, be the same as block 102 (FIG. 3 or FIG. 5) or block 102_1 or block 102_2 (FIG. 9). This block can, for example, be the same as block 204 (FIG. 8).

Block 308 of the method 300 comprises: performing the sound source enhancement mode 52. This block can, for example, be the same as block 104 (FIG. 3 or FIG. 5 or FIG. 9).

Block 310 of the method 300 comprises: ending the sound source enhancement mode 52. This block can, for example, be the same as block 106 (FIG. 3 or FIG. 5 or FIG. 9).

FIG. 11 illustrates an example where the head 20 of a user of the apparatus 10 moves along a trajectory 90 (translational movement 60, that is, a change in location in time). The apparatus 10 maintains the sound source enhancement mode 52 while the relative displacement of the apparatus 10 and the sound source 2 remains below a threshold value while the apparatus 10 is undergoing translational movement 90 (changing location). While the apparatus 10 has a location that is changing in time and the sound source 2 has a location that is changing similarly in time, then the sound source enhancement mode 52 is maintained.

In this example, a zone of focus (comprising focused directions 92) for sound source enhancement performed during sound source enhancement mode 52 is relatively narrow and is rotated to always point towards the sound source 2. The sound source enhancement mode 52 tracks the sound source 2 so that the sound source 2 remains within the zone of focus and consequently has sound source enhancement mode 52. The sound source enhancement is only applied to sound sources within the zone of focus.

It will be observed that the sound source enhancement mode 52 is maintained irrespective of the orientation of the head 20 of the user of the apparatus 10.

It will be observed that the sound source enhancement mode 52 is maintained irrespective of the orientation of the head 30 of the speaker.

It will be observed that the sound source enhancement mode 52 is maintained irrespective of the relative orientation of the head 20 of the user of the apparatus 10 and the head 30 of the speaker.

In some examples, the apparatus 10 is configured to:
while the apparatus 10 has a location that is changing in time and the sound source 2 has a location that is changing similarly in time,
   maintain the sound source enhancement mode 52 irrespective of the head orientation of the user of the apparatus 10; and
   end the sound source enhancement mode 52 when speech inactivity is detected.

In some examples, the apparatus 10 is configured to:
after starting the sound source enhancement mode 52, while the apparatus 10 has a location that is changing in time and the sound source 2 is within a threshold distance of the apparatus 10,
   maintain the sound source enhancement mode 52 irrespective of the head orientation of the user of the apparatus 10; and
   end the sound source enhancement mode 52 when speech inactivity is detected.

Some further examples are:

Based on whether or not the user 20 is in motion in some direction 60 (block 302, FIG. 10), the allowable directions 70 of a potential discussion partner (speaker 30) are determined (block 304, FIG. 10). If the user is detected to not be in motion, the assumption that a discussion partner will be in the front direction (F) is taken. If the user has been determined to be in motion in some direction, the assumption is relaxed and also the left direction (L) and the right direction (R) of the user are allowable directions 70. Sound source enhancement mode 52 may now be triggered when it is detected (block 306, FIG. 10) that the discussion partner starts talking in an allowed direction 70 as well as starting the sound source enhancement mode 52 when user of the apparatus 10 starts talking.

Detecting talking near a user 20 can be done using known methods. Sounds surrounding the user are recorded with at least two microphones. In some examples, the microphone signals are separated into speech and other sounds using blind sound source separation methods, machine learning or alternatively all other sounds than speech are attenuated using noise suppression methods or machine learning. The remaining speech signal level has to exceed a pre-determined threshold for the system to detect near speech. The detected direction 6 of the sound source 2 can be detected using known direction-of-arrival or beamforming methods.

The user's trajectory 90 is determined using GPS or other positioning means at the apparatus 10, for example. The user's location may be tracked at set intervals (1 second, for example) and his trajectory may be determined to be an (average over a window) difference between two adjacent positions. If the user's velocity in some direction is above a threshold, it may be determined that the user is in motion in this direction. Similarly, the direction the user is facing may be determined.

If the remaining speech signal exceeds the threshold and the detected direction 6 is an allowed direction 70 then the device starts the sound source enhancement mode 52.

In some embodiments the conversation partner 30 trajectory is determined too and the sound source enhancement mode 52 is started only if the user 20 and the partner trajectories are similar. Comparing user and partner trajectories can be done for example by following if the detected speech direction 6 remains the same for a period of time e.g. 3 seconds.

The sound source enhancement mode 52 may enhance voice in any direction or just in the allowed directions 70 or in focused directions 92 (which may or may not be allowed directions 70).

The sound source enhancement mode 52 may for example turn transparent mode on in both earcups/earphones of the apparatus 10 or just in the ear cup that is in the detected direction 6 of the detected speech in allowed directions 70.

The enhancement mode 52 may use beamforming to enhance speech in a focused direction 92. For this, each earcup/earphone needs at least 2 external microphones that beamform towards focused/allowed directions and play the beamformed signal using each earcup/phone speaker.

The enhancement may include using an equalizer that enhances typical speech frequencies (400 Hz-4 kHz).

Head tracking may be used to keep the beamforming direction stable with respect to user trajectory so that for example the beam is always towards right with respect to the user trajectory regardless of which direction user head is turned. The same can be used when choosing which earcup has transparency mode on.

The sound source enhancement mode 52 is ended 310 when, for a threshold time, no speech from the user or from the allowed discussion partner directions is detected.

FIG. 12 illustrates an example of a controller 400 suitable for use in an apparatus 10. Implementation of a controller 400 may be as controller circuitry. The controller 400 may be implemented in hardware alone, have certain aspects in software including firmware alone or can be a combination of hardware and software (including firmware).

As illustrated in FIG. 12 the controller 400 may be implemented using instructions that enable hardware functionality, for example, by using executable instructions 406 in a general-purpose or special-purpose processor 402 that may be stored on a machine readable storage medium (disk, memory etc.) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores instructions, program, or code 406 that controls the operation of the apparatus 10 when loaded into the processor 402. The computer program instructions, program or code am 406, provide the logic and routines that enables the apparatus 10 to perform the methods illustrated in the accompanying FIGs. The processor 402 by reading the memory 404 is configured to load and execute the instructions, program, or code 406.

In at least some examples, the apparatus 10 comprises:
at least one processor 402; and
at least one memory 404 storing instructions that, when executed by the at least one processor 402, cause the apparatus at least to:
starting a sound source enhancement mode to enhance a sound source from an allowed direction;
maintaining the sound source enhancement mode irrespective of head orientation of a user of the apparatus; and
ending the sound source enhancement mode when speech inactivity is detected.

In at least some examples, the apparatus 10 comprises:
at least one processor 402; and
at least one memory 404 storing instructions that, when executed by the at least one processor 402, cause the apparatus at least to:
modify allowed directions, relative to a user head orientation, based on translational user movement;
in dependence upon detecting a sound source at a detection direction that is an allowed direction, start a sound source enhancement mode to enhance the sound source at the allowed direction.

As illustrated in FIG. 13, the instructions, program, or code 406 may arrive at the apparatus 10 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 10 may propagate or transmit the computer program 406 as a computer data signal.

The term “non-transitory” as used herein, is a limitation of the medium itself (i.e., tangible, not a signal) as opposed to a limitation on data storage persistency (e.g., RAM vs. ROM).

In some examples, the computer program 406 comprises instructions for causing an apparatus 10 to perform at least the following or for performing at least the following:
start a sound source enhancement mode to enhance a sound source from an allowed direction;
maintain the sound source enhancement mode irrespective of head orientation of a user of the apparatus; and
end the sound source enhancement mode when speech inactivity is detected.

In some examples, the computer program 406 comprises instructions for causing an apparatus 10 to perform at least the following or for performing at least the following:
modify allowed directions, relative to a user head orientation, based on translational user movement;
in dependence upon detecting a sound source at a detection direction that is an allowed direction, start a sound source enhancement mode to enhance the sound source at the allowed direction.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all the following:
(a) hardware-only circuitry implementations (such as implementations in only analog and/or digital circuitry) and
(b) combinations of hardware circuits and software, such as (as applicable):
   i. a combination of analog and/or digital hardware circuit(s) with software/firmware and
   ii. any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the claim element, a baseband integrated circuit for a mobile device or a similar integrated circuit in a server, a cellular network device, or other computing or network device.

The blocks illustrated in the accompanying Figs may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

As used here ‘module’ refers to a unit or apparatus that excludes certain parts/components that would be added by an end manufacturer or a user. The apparatus 10 can, for example be a module. A controller 400 of the apparatus 10 can, for example be a module.

Where a structural feature has been described, it may be replaced by means for performing one or more of the functions of the structural feature whether that function or those functions are explicitly or implicitly described.

The above-described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to ‘comprising only one . . . ’ or by using ‘consisting.’ In this description, the wording ‘connect’, ‘couple’ and ‘communication’ and their derivatives mean operationally connected/coupled/in communication. It should be appreciated that any number or combination of intervening components can exist (including no intervening components), i.e., to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database, or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’, or ‘may’ refers to a particular instance in a class of examples. A property of the instance can be a property of only that instance or a property of the class or a property of a sub-class of the class that includes some but not all the instances in the class. It is therefore implicitly disclosed that a feature described with reference to one example but not with reference to another example, can where possible be used in that other example as part of a working combination but does not necessarily have to be used in that other example.

As used herein, “at least one of the following:” and “at least one of” and similar wording, where the list of two or more elements are joined by “and” or “or” mean at least any one of the elements, or at least any two or more of the elements, or at least all the elements.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

The description of a feature, such as an apparatus or a component of an apparatus, configured to perform a function, or for performing a function, should additionally be considered to also disclose a method of performing that function. For example, description of an apparatus configured to perform one or more actions, or for performing one or more actions, should additionally be considered to disclose a method of performing those one or more actions with or without the apparatus.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance the Applicant may seek protection via the claims in respect of any patentable feature or combination of features hereinbefore referred to and/or shown in the drawings whether or not emphasis has been placed thereon.

1-20. (canceled)

21. An apparatus, comprising:
at least one processor; and
at least one memory storing instructions that, when executed by the at least one processor, cause the apparatus at least to:
modify allowed directions, relative to a user head orientation, based on translational user movement;
start a sound source enhancement mode to enhance a sound source from an allowed direction;
maintain the sound source enhancement mode irrespective of head orientation of a user of the apparatus; and
end the sound source enhancement mode in response to sound inactivity associated with the sound source is detected on the allowed direction.

22. An apparatus as claimed in claim 21, wherein the apparatus is further caused to:
in dependence upon detecting a sound source at a detection direction that is an allowed direction, start the sound source enhancement mode to enhance the sound source at the allowed direction.

23. An apparatus as claimed in claim 21, wherein opposing user lateral directions are perpendicular to a user frontal direction and a user rear direction, and the modifying allowed directions comprises modifying allowed directions, relative to a user head orientation, based on a threshold of translational user movement to additionally include at least the opposing user lateral directions,
wherein the allowed directions, relative to a user head orientation, in the absence of the threshold of translational user movement include a user frontal direction but do not include the opposing user lateral directions.

24. An apparatus as claimed in claim 21, wherein the apparatus is further caused to:
in dependence upon detecting a sound source at a detection direction that is an allowed user lateral direction, start a sound source enhancement mode to enhance the sound source at the allowed user lateral direction, and
maintain the sound source enhancement mode enhancing the sound source until the sound source enhancement mode ends.

25. An apparatus as claimed in claim 21, wherein the apparatus is further caused to end the sound source enhancement mode in response to speech inactivity is detected for a user of the apparatus.

26. An apparatus as claimed in claim 21, wherein the apparatus is further caused to:
after starting the sound source enhancement mode, while the apparatus has a location that is changing in time,
maintain the sound source enhancement mode irrespective of the head orientation of the user of the apparatus; and
end the sound source enhancement mode in response to speech inactivity is detected.

27. An apparatus as claimed in claim 21, wherein the apparatus is further caused to:
after starting the sound source enhancement mode, while the apparatus has a location that is changing in time and the sound source has a location that is changing similarly in time,
maintain the sound source enhancement mode irrespective of the head orientation of the user of the apparatus; and
end the sound source enhancement mode in response to speech inactivity is detected.

28. An apparatus as claimed in claim 21, wherein the apparatus is further caused to:
after starting the sound source enhancement mode, while the apparatus has a location that is changing in time and the sound source is within a threshold distance of the apparatus,
maintain the sound source enhancement mode irrespective of the head orientation of the user of the apparatus; and
end the sound source enhancement mode in response to speech inactivity is detected.

29. An apparatus as claimed in claim 21, wherein the apparatus is further caused to:
after starting the sound source enhancement mode, while the apparatus has a location that is not changing in time,
maintain the speech enhancement mode while the head orientation of the user is towards the sound source such that the sound source is in front of the user; and
end the sound source enhancement mode in response to sound source inactivity is detected in front of the user of the apparatus and speech inactivity of the user of the apparatus is detected.

30. An apparatus as claimed in claim 21, wherein the apparatus is further caused to:
end the sound source enhancement mode in response to a timeout period expires; and
extend or re-set the timeout period based on one or more of:
audio activity of the sound source irrespective of relative orientation of the sound source to the apparatus;
speech detection of the user of the apparatus; or
head rotation of user of the apparatus towards the sound source.

31. An apparatus as claimed in claim 21, wherein the apparatus is further caused to detect speech inactivity when the sound source has been audio inactive for a time exceeding a threshold time and speech of the user of the apparatus has been audio inactive for a time exceeding a threshold time.

32. An apparatus as claimed in claim 21, wherein the apparatus is further caused to track a location of the sound source;
wherein maintaining the sound source enhancement mode irrespective of the head orientation of the user of the apparatus comprises maintaining the sound source enhancement mode while the tracked sound source remains audio active.

33. An apparatus as claimed in claim 21, wherein the apparatus is further caused to perform the sound source enhancement mode after the sound source enhancement mode has been started, while it is being maintained, wherein the sound source enhancement comprises at least one of:
frequency filtering, equalizing or amplification of the sound source;
spatial filtering captured audio to track the sound source;
controlling passthrough/transparency individually for each ear;
suppressing captured sounds other than the sound source; or
modification of audio content being privately rendered to the user of the apparatus

34. An apparatus as claimed in claim 21, wherein the apparatus uses speech activity detection for starting the sound source enhancement mode.

35. An apparatus as claimed in claim 34, wherein the apparatus uses speech activity detection for the user of the apparatus for starting the sound source enhancement mode or
wherein the apparatus uses speech sound source detection, irrespective of orientation relative to a head of the user, for starting the sound source enhancement mode.

36. An apparatus as claimed in claim 21, wherein the apparatus uses any one or more of the following for starting the sound source enhancement mode:
the apparatus has a location that is changing in time;
the apparatus has a location that is changing in time and the sound source has a has a location that is changing similarly in time; or
the apparatus has a location that is changing in time and the sound source is within a threshold distance of the apparatus.

37. An apparatus as claimed in claim 21, configured as a head-mounted apparatus.

38. A method comprising:
modifying allowed directions, relative to a user head orientation, based on translational user movement;
starting a sound source enhancement mode to enhance a sound source from an allowed direction;
maintaining the sound source enhancement mode irrespective of head orientation of a user of the apparatus; and
ending the sound source enhancement mode in response to sound inactivity associated with the sound source is detected on the allowed direction.

39. A method as claimed in claim 38, comprising:
in dependence upon detecting a sound source at a detection direction that is an allowed direction, starting a sound source enhancement mode to enhance the sound source at the allowed direction.

40. A non-transitory computer readable medium comprising program instructions stored thereon for performing at least the following:
modifying allowed directions, relative to a user head orientation, based on translational user movement;
starting a sound source enhancement mode to enhance a sound source from an allowed direction;
maintaining the sound source enhancement mode irrespective of head orientation of a user of the apparatus; and
ending the sound source enhancement mode in response to sound inactivity associated with the sound source is detected on the allowed direction.
